(19) United States
(12) Patent Application Publication
(10) Pub. No.: US 2017/0249713 A1
(43) Pub. Date: Aug. 31, 2017

(54) SYSTEM AND METHOD FOR HEALTH PROVIDERS TO DELIVER PROGRAMS TO INDIVIDUALS

(71) Applicant: League, Inc., Toronto (CA)

(72) Inventors: Michael Serbinis, Toronto (CA); Daniel Leibu, Toronto (CA); Dan Galperin, Toronto (CA); Todd Humphrey, Toronto (CA); Pamela Hilborn, Toronto (CA); Damian Lewis, Toronto (CA); Daniel Brandt, Toronto (CA); Kevin Birch, Toronto (CA)

(73) Assignee: League, Inc., Toronto, ON (CA)

(21) Appl. No.: 15/511,156

(22) PCT Filed: Sep. 11, 2015
(86) PCT No.: PCT/CA2015/050884

§ 371 Date: Mar. 14, 2017

Related U.S. Application Data
(60) Provisional application No. 62/050,196, filed on Sep. 14, 2014.
(60) Provisional application No. 62/162,283, filed on May 15, 2015.

(51) Int. Cl. G06Q 50/22; G06F 19/00

(52) U.S. Cl. CPC G06Q 50/22; G06F 19/3481; G06F 19/3487

(57) ABSTRACT

The disclosure recites a system and method for managing relationships among records in a database of services provided by health professionals and users. The method comprises: creating and maintaining a first set of records in the database for a user, the first set of records including fields for a name, contact information and a goal; creating and maintaining a second set of records in the database for health professional records in the second set including fields for a name, programs and activities; analyzing the database to identify a set of health professional records in the second set of records that match the goal in the first set; generating and sending a set of programs offered by the set of health professionals to an account associated with the user; and track progression of a selected program in a network, such as a social network.

### RELATED FILING

This application is related to U.S. provisional patent application Ser. No. 62/050,196 filed on Sep. 14, 2014 and U.S. provisional patent application Ser. No. 62/162,283 filed on May 15, 2015.

### FIELD OF DISCLOSURE

The disclosure is related to a system and method for service providers to deliver programs to individuals. In particular, the disclosure provides a system and method for identifying, managing and linking services provided by various different professionals, such as health service professionals, to needs identified by individuals (as clients). The services can be identified from goals identified by the users. The system may produce a calendar of activities for the individuals based on services that they have selected. Updates to the calendar are provided by the users as activities are completed (fully or partially) or not completed. Additional data relating to an activity may be provided by monitoring devices. Feedback and updates are provided to the user and the health service professionals.

### BACKGROUND

There is much attention and focus currently on a person's well-being and general state of health. Diet, exercise and other physical and mental health programs are offered by various health professionals (herein referred to as “HPs”) to users in the public. Typically, an individual personally takes charge of identifying potential HPs, vetting and contacting selected HPs and developing routines and regimes to implement health programs to achieve desired goals (e.g. lose weight, increase flexibility and strength, eat nutritionally balance meals, etc.). An individual has a myriad of choices within a class of professionals as well as across different classes for certain goals. As such, there are overlapping and occasionally conflicting services available to the individual, making selection of an HP difficult. Further, once a HP is selected, there are issues with managing an action program proposed by the HP by the individual.

There is a need for a system and method which addresses deficiencies in current prior art.

### SUMMARY OF THE DISCLOSURE

In a first aspect, a method for managing relationships among records in a database of services provided by health professionals and users is provided. The method comprises: creating and maintaining a first set of records in the database for a user, the first set of records including fields for a name, contact information and a goal; creating and maintaining a second set of records in the database for health professional records in the second set including fields for a name, programs and activities; analyzing the database to identify a set of health professional records in the second set of records that match the goal in the first set; generating and sending a set of programs offered by the set of health professionals to an account associated with the user; and tracking progress of execution of a program of the set of programs from a health professional of the set of health professionals through a network.

The method may provide an interface for receiving feedback data from the health professional and third party members in the network on the program; and for generating audio, graphic and video files associated with the program in a graphical user interface (GUI).

The method may further comprise: generating on a device associated with the account of the user a GUI providing details of the set of programs; receiving on the device a selected program from the set of programs; sending to the database data on the selected program; and associating the selected program with the first set of records.

The method may further comprise generating on the device associated with the account of the user a second GUI providing details of activities associated with the selected program at times relating to the activities.

The method may further comprise playing on the device a song or listing instructions associated with an activity of the activities when the activity is to be conducted, wherein the second set of records contains details linking the song to the activity.

The method may further comprise tracking telemetrics from a second device providing usage details imparted by the user while executing an activity of the activities.

The method may further comprise tracking completion data of an activity of the activities in the database.

The method may further comprise: analyzing the database and the completion data to identify a modification to the goal for the user; generating on the device a third GUI providing details of the modification relating to the activity; receiving at the device instructions for any modification relating to the activity; and updating the database and the selected program with the any modifications to the activity.

The method may further comprise: analyzing the database and the completion data to identify a modification to programs in the second set of records; generating a report providing details of the modification relating to the second set of records; and transmitting the report to at least one account of a health care professional in the set of health professional records.

In the method analyzing the database to identify a set of health professional records may comprise applying a normalization analysis against the programs.

The method may further comprise: generating on the device associated with the account of the user a second GUI providing details of a set of health plans available to the user; receiving on the device a selected health plan from the health plans; sending to the database data on the selected health plan; creating and maintaining a third set of records in the database for the user, the selected health plan and health professional records associated with the health plan; and tracking progress of execution of a program of the health plan through the network.

In the method, parameters of the set of health plans may be set by a health coach account having access to data relating to the user and the health professional records in the database.

In a second aspect, a server for managing relationships among records in a database of services provided by health professionals and users is provided. The server comprises: a processor; a first communication link to a database; a second communication link to a network; and a memory storage device. The memory storage device contains a first application that provides instructions for execution on the microprocessor to: create and maintain a first set of records in the database for a user, the first set of records including fields for a name, contact information and a goal; create and maintain a second set of records in the database for health professional records in the second set including fields for a name, programs and activities; analyze the database to identify a set of health professional records in the second set of records that match the goal in the first set; generate and send a set of programs offered by the set of health professionals to an account associated with the user; and track progress of execution of a program of the set of programs from a health professional of the set of health professionals through a network.

In the server, the memory storage device may contain a second application that provides instructions for execution on the microprocessor to generate an interface for receiving feedback data from the health professional and third party members in the network and generate audio, graphic and video files associated with the program in a GUI.

In the server, the first application may provide further instructions for execution on the processor to: generate on a device associated with the account of the user a GUI providing details of the set of programs; receive on the device a selected program from the set of programs; send to the database data on the selected program; and associate the selected program with the first set of records.

In the server, the first application may provide further instructions for execution on the processor to generate on the device associated with the account of the user a second GUI providing details of activities associated with the selected program at times relating to the activities.

In the server, the first application may provide further instructions for execution on the processor to play on the device a song associated with an activity of the activities when the activity is to be conducted, wherein the second set of records contains details linking the song to the activity.

In the server, the first application may provide further instructions for execution on the processor to track telemetrics from a second device providing usage details imparted by the user while executing an activity of the activities.

In the server, the first application may provide further instructions for execution on the processor to track completion data of an activity of the activities in the database.

In the server, the first application may provide further instructions for execution on the processor to: analyze the database and the completion data to identify a modification to the goal for the user; generate on the device a third GUI providing details of the modification relating to the activity; receive at the device instructions for any modification relating to the activity; and update the database and the selected program with the any modifications to the activity.

In the server, the first application may provide further instructions for execution on the processor to: analyze the database and the completion data to identify a modification to programs in the second set of records; generate a report providing details of the modification relating to the second set of records; and transmit the report to at least one account of a health care professional in the set of health professional records.

In the server the database may be analyzed to identify a set of health professional records by applying a normalization analysis against the programs.

In other aspects, various combinations of sets and subsets of the above aspects are provided.

### DESCRIPTION OF THE DRAWINGS

Embodiments of the present disclosure will now be described, by way of example only, with reference to the accompanying drawings, in which:

FIG. 1 is a schematic diagram of an exemplary system where an embodiment may be deployed, the system including a server and database in a network, the network connected to a user's device and a health professional's (“HP's”) device;

FIG. 2 is a flow chart of exemplary overall functions executed by user's device and the HP's device in the system of FIG. 1 by an embodiment;

FIG. 3 is an exemplary GUI generated on a display of the HP's display of her device in the system of FIG. 1 when establishing a program to be offered for use by an embodiment;

FIG. 4 is a flow chart of exemplary functions executed by the HP's device in the system of FIG. 1 in establishing his programs for users in an embodiment;

FIG. 5 is an exemplary graphical user interface (GUI) generated on a display of the user's device of FIG. 1 when establishing a subscription for programs for the user in an embodiment;

FIG. 6 is a flow chart of exemplary functions executed by the user's device in the system of FIG. 1 in establishing and executing a program for the user by an embodiment;

FIG. 7 is an exemplary GUI generated on the display of the user's device of FIG. 5 when a selection of programs is generated on the user's device;

FIG. 8 is an exemplary GUI generated on the display of the user's device of FIG. 1 while an application tracking an activity is operating on the user's device;

FIG. 9 is a flow chart of exemplary functions executed by the user's device of FIG. 1 by an embodiment during and after execution of an application tracking a program by the user;

FIG. 10 is an exemplary GUI generated on the display of the user's device of FIG. 1 providing a feedback report on his program;

FIG. 11 is a flow chart of exemplary user analysis functions executed by the server in the system of FIG. 1 after execution of a program for the user;

FIG. 12 is a flow chart of exemplary HP analysis functions executed by the server in the system of FIG. 1 after execution of programs by users;

FIG. 13 is a flow chart of exemplary functions executed by the user's device in the system of FIG. 1 in establishing and maintaining parameters for a program for the user by an embodiment by a social media application operating on the user's device;

FIG. 14 is an exemplary GUI generated on the display of the user's device by a social media application operating on the user's device of FIG. 13;

FIG. 15 is a flow chart of exemplary overall functions executed by user's device and the HP's device in the system of FIG. 1 for selection and execution of a plan by an embodiment;

FIG. 16 is an exemplary GUI generated on the display of the user's device for a calendar application monitoring a plan operating on the user's device of FIG. 15;

FIG. 17 is a schematic diagram of components of the server in the system of FIG. 1 according to an embodiment; and

FIG. 18 is a schematic diagram of components of the user's device (and the HP's device) in the system of FIG. 1 according to an embodiment.

### DETAILED DESCRIPTION OF EMBODIMENTS

The description which follows and the embodiments described therein are provided by way of illustration of examples of particular embodiments of the principles of the present disclosure. These examples are provided for the purposes of explanation and not limitation of those principles and of the disclosure. In the description which follows, like parts are marked throughout the specification and the drawings with the same respective reference numerals.

Briefly, the disclosure is directed to providing systems, methods and devices to enable individuals to access, create, manage and track health programs and activities in programs offered by third party provider through a network. In one embodiment, an application manages health programs offered by health professionals (HPs). HPs can be grouped into various general classes (e.g. fitness professionals, nutritionists, chiropractors, massage therapists, psychiatrists, career coaches, doctors, etc.). The term HP is not meant to be limiting to just the health professionals described herein.

Several aspects of an embodiment are first introduced herein. More details on the exemplary aspects an embodiment are provided later. Each aspect provides advantages independent of the others, but there is also a synergy when multiple aspects are combined.

One aspect of an embodiment provides a calendar application operating on an individual's electronic communication device (such as a smartphone, tablet, smart watch, laptop or home computer) that provides reminders and updates to the user through a graphical user interface (GUI) generated on the display of the device. The calendar application refers to a list of scheduled activities from a program of activities that the individual is encouraged to complete. In one embodiment, the program relates to a personal fitness/wellness regime that the individual has selected from suggested programs selected and presented on the device. In a fitness/wellness regime, activities in a program can be related to one or more actions relating to exercise, diet, stress management activities, medication programs and others. The server analyzes information provided by the individual relating to desired features in a program that is tailored for the attributes of the individual (e.g. age, gender, current fitness level, desired goal, ailments, allergies, etc.). Inputs for the tailored program are provided in a database of programs of HPs in the system.

Another aspect of an embodiment provides calendar notifications to an individual's electronic device based on a program selected by the user. The calendar may provide periodic tracking notifications (e.g. weekly, daily, hourly, etc.) based on the timing and/or number of activities provided in the program. As a time for an activity arrives, a customized notification can be generated on the device to assist the individual in completing the activity. Telemetric data (e.g. from wearable devices, such as wearable fitness bands or from applications operating on devices) may provide data relating to the activity (e.g. start time, stop time, pulse, blood pressure, blood sugar level, etc.). Instructional videos, encouragement messages, music playlists and goals for the activity may be presented on the device at relevant times. The individual may also track and record updates relating to the activity (e.g. completion of the activity, notes on ambient conditions, pictures, etc.). The updates may be entered by the user on an application and/or telemetric data from a device as noted. Additional status updates may be provided to and from social network applications (e.g. Facebook, Twitter both trade-marks). Still another aspect of an embodiment provides the notifications, update and tracking tools in an enriched multimedia GUI to encourage and motivate the user to complete the current activity in his program.

Another aspect provides real-time or near real-time tracking of progress of a user as he is executing activities in a fitness plan. Feedback is provided to the system on whether the user has started the activity, his level of progress for the activity, whether the activity was completed or not and any additional information about the user's completion (or not) of the activity. This information is provided as feedback to the HP and allows the HP to update his program in view of the feedback.

Yet another aspect of an embodiment collects data associated with activities in a program and analyzes the data to uncover insights in areas of improvement and weakness in the activities/program and to generate a report to the individual on same.

Another aspect of an embodiment collects data associated with activities of programs of multiple individuals in the system and multiple programs provided by multiple HPs and analyzes the data to uncover insights in general trends and characteristics of different demographics in the population of users (e.g. data on activity performances by gender, age group, income, location and/or other characteristics of individuals). These characteristics are then analyzed against features of programs offered by the HPs to identify areas of improvement and weakness in the programs and to generate reports to HPs on the effectiveness of their programs.

Still another aspect of an embodiment collects data associated with activities of programs of multiple individuals in the system and multiple programs provided by multiple HPs and analyzes the data to uncover insights in general trends and characteristics of different demographics in the population of users (e.g. data on activity performances by gender, age group, income, location and/or other characteristics of individuals). These characteristics are then analyzed against features of programs offered by the HPs to identify areas of improvement and weakness in the programs and to generate reports to HPs on the effectiveness of their programs.

Yet another aspect of an embodiment creates, analyzes and manages personal data, program data, ancillary files and electronic communications for a user through a GUI generated on an electronic device associated with the user. The GUI provides an electronic bulletin board for indicating daily items that the user is scheduled to perform relating to a subscribed program. Ancillary items, such as video files, music files and messages may be posted to the GUI as the user progresses through the program. Additional customization features permit the user to tailor what information is presented in the GUI, which HPs are permitted to present program offerings to the user and other settings.

Yet another aspect of an embodiment creates, analyzes and manages various plans, such as health plans or activity plans. Health/activity plans are goal-oriented organizational objects that collect and organize one or more programs offered by one or more HPs that provide a service directed to achieving a goal for that plan. The plans may be built from one or more activities that the user selects (including from activities identified and tracked by an embodiment). Once activities for a plan are selected and activated, an embodiment may track appointments and tasks for the user and generate suitable reminders and messages through a calendar application (or another tracking application). In operation, the user selects a plan (e.g. “train for marathon” plan) from a GUI and then the system analyzes programs offered by HPs that may sufficiently match one or more attributes associated with the plan. The user is then presented with offers from the selected HPs for their services and then the user selects the HPs that she wishes to engage with for the plan. The selected HPs are notified of their selection for the plan and the HPs may contact the user to offer more information about the HP's services for the plan. Once the user selects the relevant service(s) for the plan, the services offered by the selected HPs may then be integrated into the user's calendar data. Actions, appointments, activities, articles, messages, videos, music, progress/completion data and charts and other data are presented on a GUI of the user's device when activities associated with the plan are to be initiated. Backend billing and accounting data is exchanged and tracked for accounts for the HP and the user by an embodiment.

In this disclosure, a “program” refers to a set of one or more discrete “activities” that collectively make up components of the “program”. For example, a fitness HP may define a fitness program comprising daily exercises that involves the following activities: walk for 20 minutes; lift 5 lb dumbbells for 10 minutes; and walk for another 10 minutes. Motivational messages, song lists, instructional videos and other data can be associated with each activity. That same fitness HP may define a second “high-intensity” fitness program comprising daily exercises that involves the following activities: run at least at 10 km/h for 30 minutes; lift 15 lb dumbbells for 3×10 repetitions; and perform 25 sit ups. Different variations on the programs may be provided for different genders and different age groups (e.g. 15-35; 30-50; 45-55; 50-65; 60 and older, etc.). A second fitness HP may define other “high-intensity” fitness programs comprising daily exercises that involve different combinations of swimming, bicycling and rock climbing. Similarly a nutritionist may define a series of programs that are directed to certain goals for specific demographics, such as a weight loss program for men older than 40, comprising a first daily diet of meals at 9 AM, 12 PM and 6 PM consisting of specific foods having a determined caloric intake and a second daily diet of meals at 8 AM, 1 PM and 7 PM and snacks at 11 AM and 3 PM consisting of specific foods having a determined nutritional value, where the program alternates between the two diets every day. As such, when all HPs have their specific programs and activities entered into the system of an embodiment, the system has a library of different programs and activities from one or more HPs that can be examined and matched up (in whole or in part) against goals identified by users.

A separate service enables a health coach professional to establish an account and to access a set of HP programs to develop a health plan that incorporates one or more HP programs into a specific health plan for a user. The embodiment provides data access and communication for health coaches (as special HPs, discussed below) to enable the system-enabled health coaches to interact with users regarding goals of the user using the health plan as an improvement tool to set a series of programs to work towards the goals and track the efforts in completing the programs. The embodiment provides facilities for the health coach and user to create, monitor, adjust a plan, once activated, through their accounts.

Multiple programs can be offered to a user or group of users. An embodiment analyzes data relating to an individual's personal health information and desired goal (described later) and conducts analyses of these parameters for a user and identifies one or more programs (in whole or in part) that sufficiently match the (most significant) requirements of the user. These programs are presented to the user and the user reviews the programs and selects which program(s) (in whole or in part) that he wishes to implement. The selected program(s), in addition to activities selected by a user, form a customized “plan” for that user. An embodiment then processes administrative details for the accepted programs in the plan (e.g. confirmation of registration, billing, etc.) and then implements a series of reminders through a calendar application and other notifications (e.g. flashing lights, speaker tones, recorded voice messages, text messages, etc.) generated on a device that the user has with him (e.g. a smart phone), where for a given day, for the programs in the plan, each activity for the set of plans is diarized and appropriate reminders and completion tracking schemes are provided through the calendar application and other notification mechanisms on the device.

With general features of an embodiment described, details of an environment in which exemplary embodiments operate are now provided.

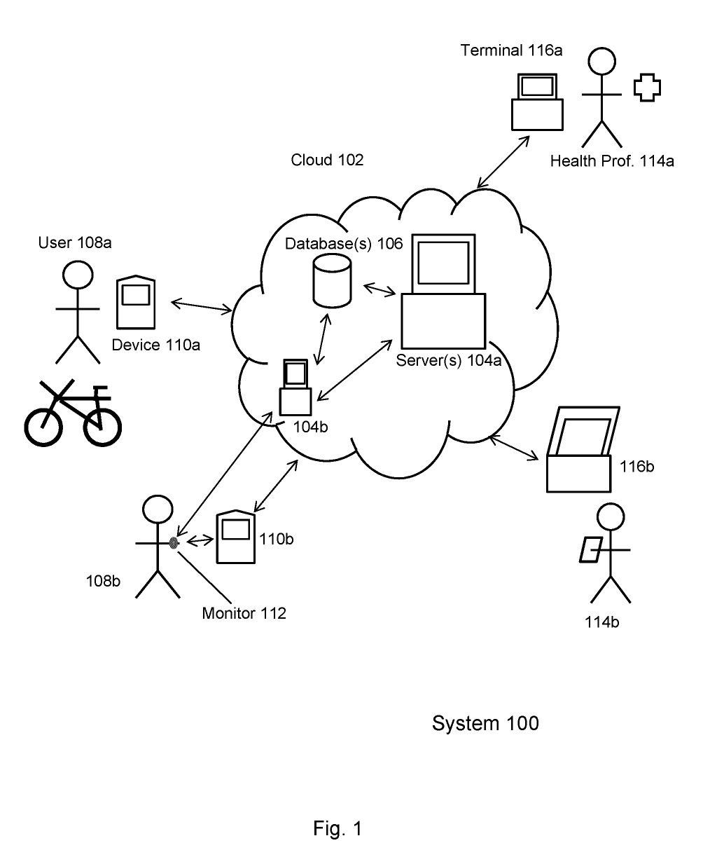

Referring to FIG. 1, system 100 shows an exemplary computer network in cloud 102 that includes connected server(s) 104 and databases 106. The databases contain data on individuals in system 100 including, their selected health program(s) and activities in the programs. The database also contains data on programs offered by various HPs connected to system 100. Individuals in system 100 are shown as users 108. Herein the terms individual and user are used interchangeably unless otherwise noted. Users 108 have electronic communication devices 110 associated with them. Electronic communication devices 110 (or simply devices 110) may be smartphones, tablets, smart watches, laptops and/or computers. Devices 110 provide an electronic link for users 108 to servers 104. For example user 108a has smartphone device 110a on his person and he uses device 110a to record and track completion of an activity (e.g. riding a bicycle) associated with his selected health program. User 108b has her device 110a that she uses to record and track completion of activities (e.g. jogging, push ups) associated with her selected health program. User 108b also has a wearable monitoring device 112 that provides telemetrics of her body measurements to server 104a. Here, monitor 112 is a heart rate monitor attached to her wrist, which detects a pulse in the user's wrist and periodically sends data on her heart rate to device 110b and/or to dedicated heart rate server 104b in cloud 102. This heart rate data may be incorporated into the activity data for her program. User 108a on his device 110a may have telemetric applications operating thereon that provide different telemetric data to server 104a for his activities (e.g. an electronic pedometer, temperature readings, GPS readings, etc.). HPs 114 are connected to system 100 through their devices 116. Each HP offers a platform of various services according to his/her specialty. Server 104a can track multiple HPs having similar qualifications and services and HPs having very different qualifications. Services that an HP provides are tracked by server 104a and data relating thereto is stored in database 106. Server 104a also tracks, manages, links and analyzes activities and programs of users 108 and relationships with HPs 114 and even other users 108. Users and HPs access features of an embodiment through accounts managed by server 104. Messages may be sent to various accounts from server 104 to both HPs and users. HPs and users access their accounts by signing on to their accounts through their associated devices (terminals 116/devices 110) or other devices.

Relationships between entities tracked in the system may be one directional or bi-directional. Users and HPs are exemplary entities to the system. Relationships may be established between users/HPs, users/users and HPs/HPs in different relationships, such as one-to-one (1:1), one-to-many (1:N), many-to-one (N:1) and many-to-many (N:M). Relationships are tracked in the database through accounts of the HPs and users. These relationships follow relational database constructs and naming conventions. Association strengths may be assigned for such relationships among entities and differing association strengths may be provided for one entity for its associations with other entities.

Database 106 tracks and manages events and relationships among entities tracked in the system. In one embodiment, database 106 is organized as a graph database, which manages relations among its entities. Entries are stored as graphs. A basic graph is a node having assigned properties which are organized with express relationships. Queries are executed as “path traversals” of a graph. An exemplary graph database system is Neo4J (trademark).

Other database formats may be provided. For example, in another embodiment, database 106 is organized as a relational database. In another embodiment, a database may be implemented as a relational database. One exemplary relational database is provided in Microsoft Access (trade-mark), a commercial software application package. A further embodiment may implement a database system using SQL. A separate database server (not shown) may be associated with database 106 or the database server or the database server may be incorporated into server 104a.

Server 104a and database 106 in system 100 also provide data analysis on its stored programs of HPs 114 and activities and programs of users 108. Results in of the analysis can identify areas for change in programs/activities executed by users 108 and/or programs/activities offered by HPs 114.

With general features of an exemplary operating environment for an embodiment described, general functions of an exemplary embodiment are described.

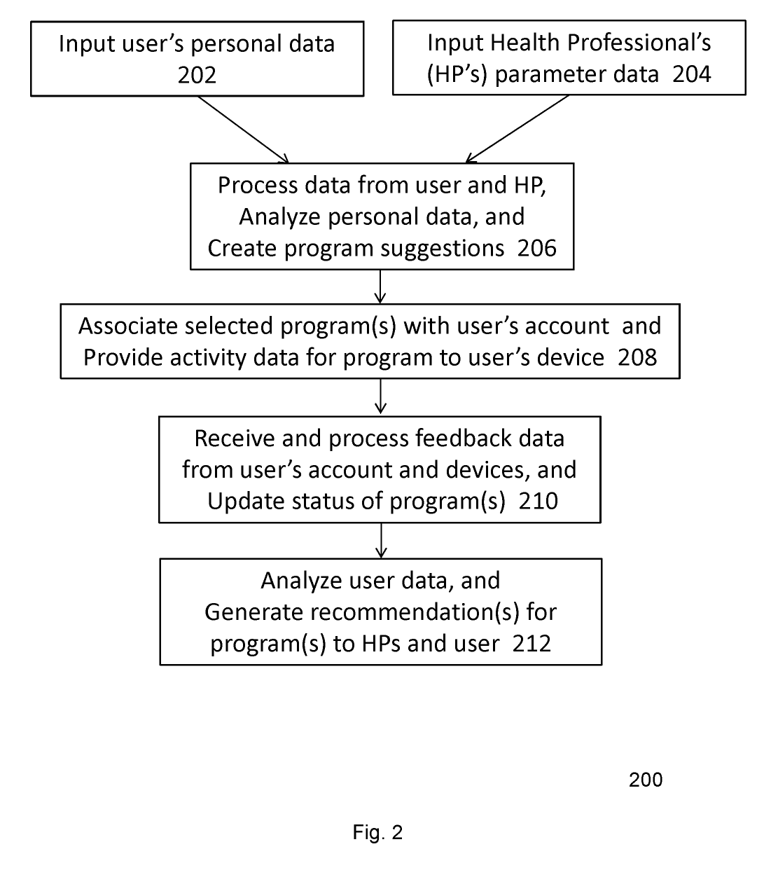

Referring to FIG. 2, flow chart 200 shows functions and operations executed by various components in system 100 for an embodiment. Functions in chart 200 may be independently and in parallel executed by device 110 on users 108, terminals 116 by HPs 114 and by server 104a and database 106.

In flow chart 200, user 108 may activate a health tracking application operating thereon and input data relating to his personal information and desired activities and goals in process 202. This data is stored in database 106 and will be used by server 104a to identify a set of proposed programs, which may be an amalgamation of programs offered by HPs 114 that have provided their program data to server 104 per process 204. Note that processes 202 and 204 operate independently of each other. Further details on these processes is described below.

Once user and HP data is provided to server 104 and database 106, server 104 processes data from the users and HPs, analyzes the personal data against the program data provided by the HPs, normalizes the data and identifies a set of programs suitable for the user's goals and abilities (as stated in his program goals and analyzed from his personal data) per process 206. Further detail on data normalization is provided below.

Next at process 208, once user 108 provides a selection of a program on his device 110, server 104 associates the selected program with the user's record in database 106 and generates and provides activity data to the user's device 110. The data is received by the user's device 110 and is accessed by the above-noted health tracking application operating on device 110.

The application operating on device 110 (described in more detail below), provides a real time calendar application that notifies the user of activities relating to the selected program in his plan (at the relevant start time), provides access to additional details and information (e.g. video clips and song lists) associated with a particular activity and tracks telemetric data and completion notifications for the activity as inputted to device 110. In a different configuration, server 104 provides notification and tracking functionalities of the application operating on device 110.

Next at process 210, as the application operating on device 110 tracks progress and data for an activity, server 104 receives that data and stores the data in database 106 and updates the status of the related programs being executed for the user's plan.

Activities tracked for the universe of users 108 in system 100 may be updated in system 100 as follows. At certain instances (e.g. at time intervals, such as daily, nightly or weekly) or event occurrences (e.g. upon completion of each activity by one or more users 108, upon completion of a program by one or more users, etc.), data relating to activities (e.g. completion rates, percentage completion rates, catastrophic events, etc.) is analyzed by server 104 and server 104 applies heuristics to identify areas of improvement and/or change for the programs offered by the HPs. Based on the analysis and heuristics, server 104 can generate recommendations for changes to user 108 for his current program/activity, alerts pertaining to a health condition detected for a user (based in part on feedback provided for his plan being executed) and recommendations for changes to HPs 114 for their offered programs/activity lists.

Now, further details are provided on specific functions provided by an embodiment, including: a) creation and storage of programs by HPs; b) subscription processes by users; c) delivery of selected program(s) to users; d) monitoring and updating of activity statuses for programs of users; e) data analysis on activities provided to HPs; f) data analysis providing recommendations and alerts to HPs; g) health team management; and h) management, tracking and presentation of programs and ancillary materials employing social network functionalities. Each function a)-h) is described in turn. It will be appreciated that each function a)-h) provides an independent aspect of an embodiment. Functions may be combined to produce additional synergies for an embodiment.

First, further exemplary details are provided on function a), relating to creation and storage of programs by HPs 114 and health coaches. Briefly, in creation and storage of programs by HPs, each HP 114 in system 100 provides data relating to programs of services that he is offering to users 108.

To assist a HP 114 with entering data relating to his programs, a program management application (PMA) executing on his terminal 116 provides an interface for data entry and report provided by server 104. The PMA provides an interface and authoring tools on terminal 116 for an HP 114 to create programs tailored to his/her services. As earlier, programs comprise a schedule of activities and messages/videos that are provided to a user 108 on her device 110.

The PMA also has processes to identify and create a template of a program that incorporates identified recommended activities. The template is populated by activities or characteristics of activities that have been determined to be useful, such as a “best practice” or “effective activity”, in achieving the stated goal. The usefulness evaluation is determined from heuristics that evaluate data of recorded results of practices and their activities tracked in database 106. For example, if an HP desires to create a “high-intensity fitness” program for a male of age between 40 and 50, template can be generated based on an analysis users' success levels for all programs tracked in database 106, which may include users that do not meet any or all of the stated criteria, weighted accordingly. The analysis may identify that a successful “high-intensity fitness” program includes an activity of running for 30 minutes a day. This characteristic can be included as a selectable default activity in the “high-intensity fitness” program template.

When a program is created, in one embodiment system 100 also creates a semantic representation of the program, providing an abstracted version of the program. This representation can be used by system 100 as a standardized representation of the program enabling analyzing and comparing features of the program against other programs and other data metrics. For example, the semantic representation may be used to: normalize all or many programs/activities in database 106; associate third party devices 112 to programs/activities; and apply large data analysis techniques to identify template suggestions (noted above).

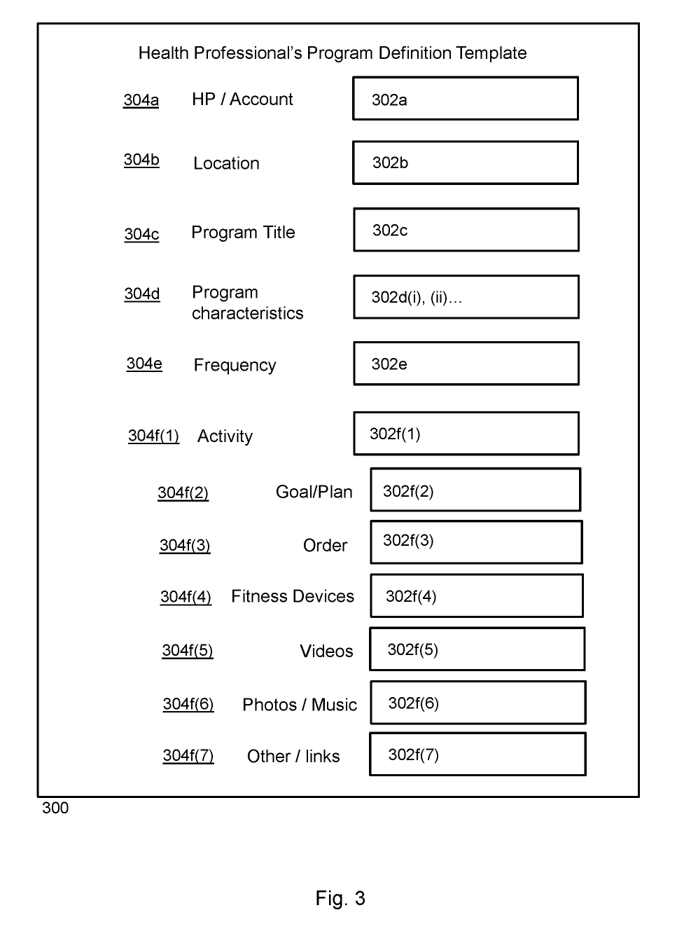

Referring to FIG. 3, when HP 114 activates the PMA on his terminal 116 and wishes to create a new program, a set of GUIs is generated to allow him to enter data for characteristics of the program. Screen shot 300 shows a basic GUI layout of text boxes 302 and descriptions 304 that allow HP 114 to enter parameters and characteristics for the program being created. Once the data is entered, the program characteristics can be stored in database 106. For example boxes 304a-304e allow HP 114 to enter data relating to the identification of the HP, his account, studio location, a title for the program (e.g. “Men's aerobic—daily”), target characteristics of the program (e.g. high-intensity/male/25-45 age/cost is $60 per session or/3 sessions for $150, etc.) and the frequency of the program (e.g. daily, weekly, monthly, etc.). As noted, a program is comprised of a series of connected activities, that are typically (but not always) conducted sequentially. Boxes 304f(1)-304f(7) are provided to allow HP 114 to enter attributes for one activity, including the activity type (e.g. running, walking), goal (e.g. 30 minutes), order (e.g. first activity in program), fitness device that can provide data for activity (e.g. electronic pedometer), links to videos associated with activity (e.g. instructional video on proper walking technique that can be accessed by user 108 on his device 110 when program is being followed), photographs/music links (e.g. inspirational photographs and music that can be accessed on device 110) and other data. Multiple activities can be added in sequential sets of boxes 304f(1)-304f(7).

Data entered from the PMA is stored in database 106 as a program record associated with an account of the HP, but the program record may include additional data. Table A below is an exemplary program record for a HP.

### Table A

TABLE A

| Field | Data |
|---|---|
| Health Professional | Ellen's Fitness |
| Address | 1 Main Street, |
| | Toronto Ontario |
| Program Title | High-Intensity-Women |
| Characteristics | High-Impact/Woman/25-45 age/ |
| | $60 per hr |
| Frequency | Daily |
| Intensity Level | Medium/high |
| 1^{st} Activity | Running |
| Goal | 30 minutes |
| Order | 1^{st} activity in program |
| Fitness Device(s) | Electronic Pedometer/account |
| Video | Running Video 1 |
| Photos/music | Rdio feed |
| lists | |
| Other | Send message on initiation |
| 2^{nd} Activity | Swimming |
| . . . | . . . |
| Notes | Insurance rebate eligible/AAA |
| | insurance |

More or less fields can be provided to describe a program. Fields may or may not be populated for a given program.

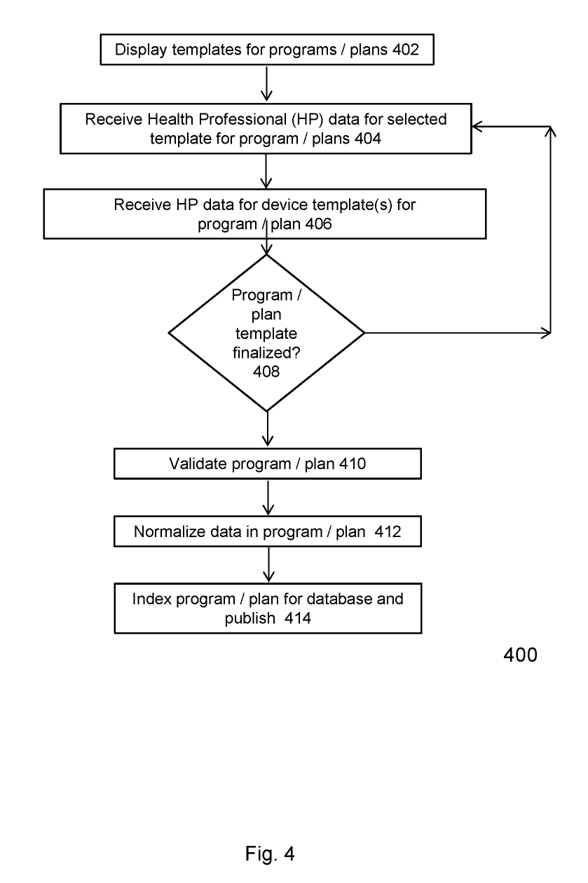

FIG. 4 shows flow chart 400 of functions operating on server 104 in processing program definition inputs by HPs 114 (at terminals 116) as executed by the PMA and processes operating on server 104. This process may also be used to validate HP submissions for plans (which are discussed in more detail below). First at process 402, templates are displayed on terminal 116 for processing of programs/plans, such as screen shot 300. At processes 404-408 a loop is provided where HP enters data for a program/plan, then the data is transmitted to server 104 and then loop back is provided for more data entry if the program is not finalized.

Once the program is finalized, additional data analysis is conducted on the raw data of the stored program. At process 410, constructs of the program/plan are validated (e.g. checking whether the HP's account is active). At process 412, parameters in the program/plan are normalized. Normalization involves analyzing the data and conducting basic normalization on data, such as converting units of measure to a standard format (e.g. metric, time in HH:MM:SS, dates as YYYY:MM:DD, etc.). It may also transpose the descriptions of received programs to a standard canonical form. For example, if an activity is described as a “push up” or a specific type of push-up (e.g. planche, knuckle, Maltese, Hindu, guillotine, backhanded, one arm, using push up bars, etc.), then applying a normalization of a push-up activity to a standard canonical term maps any instance of any form of a push up to simply a “push up” (for analysis purposes). The specific variant is still retained in the record. With a program/plan having activities tracked in a standard canonical form, data analysis can be used to on those forms to compare programs, create benchmarks, compare benchmarks against community data, receive data/information from third party device applications, etc. Another normalization calculates effective cost per session data. For example, if a program offered by an HP is priced at $60 per session once per week and a second program is priced at three sessions every two weeks at $160, then normalized costs can be calculated for each program on different bases (e.g. on a per session basis, on a cost per week basis, on a cost per biweekly basis, etc.). These normalized cost values can then be presented to the user in a GUI, facilitating the user in making a more informed decision on what program(s) best fit the need(s) of the user. Database 106 contains data relating to canonical standards for activities and programs that may be used to conduct a normalization analysis. The normalized data may be supplemented with real-time data provided in the field as programs are executed and feedback information is collected. Normalization may also include organizing/pruning fields in the program to minimize redundancy and dependency among fields.

As noted earlier, a health coach may be a specialized HP. An embodiment provides an interface for accounts for designated health coaches that permit the health coaches to access selected data about users and HPs. The health coaches can then develop customized health plans for users that may fine tune goals and tasks for a specific user's selected plan. The interface provides GUIs that facilitate the selection of HPs and services for a user and communication interfaces. These features may incorporate one or more processes described in FIGS. 2 to 4 as described above.

Next, further exemplary details are provided on function b), relating to creation and management of a subscription to a customized set of programs in a plan by user 108. An embodiment provides information for a marketplace of programs offered by HPs and provides facilities to search for programs, subscribe to selected programs and then track performances as programs are executed by the users. An embodiment provides a plan management application (PLMA) executing on device 110 that presents information on programs stored in database 106 and provides search facilities to filter and identify programs of interest to the user in a selection of a plan. The PLMA may also track execution of the plan and provide feedback on completion and ratings of specific activities and programs in the plan. The feedback and ratings for the programs is stored in database 106 and an analysis of the feedback and ratings is used to tailor additional messages and inputs provided to the user on his device 110 while the PLMA is operating. Heuristics and data analysis algorithms, based on information relating to user 108 and the library of programs allow relevant programs to be identified for user, based in part on his stated goals and goals defined in the programs.

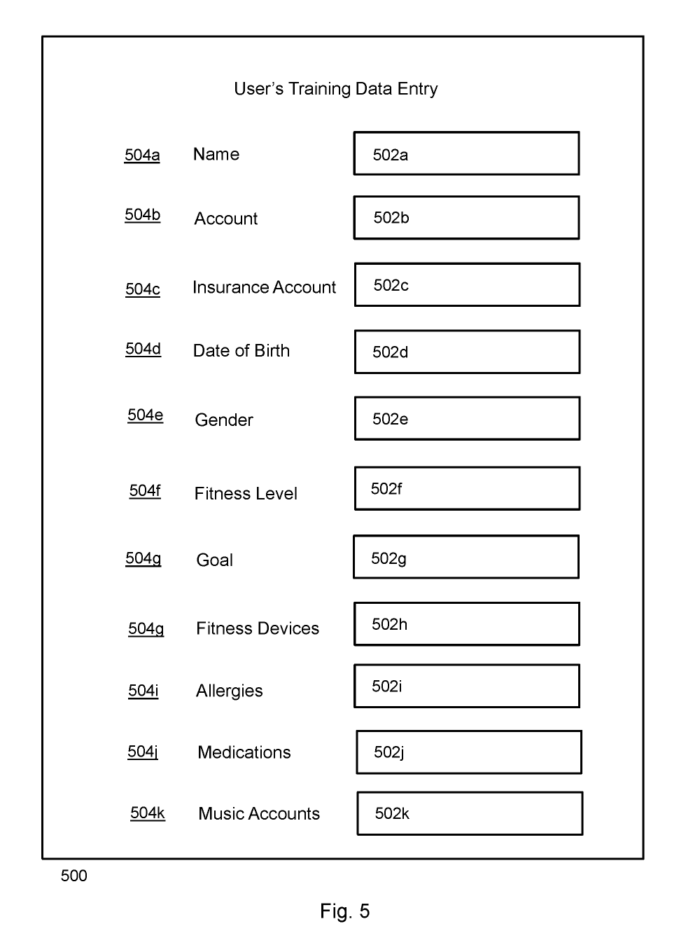

Referring to FIG. 5, when user 108 activates the PLMA on his device 110 and wishes to subscribe to the system of an embodiment, a set of GUIs is generated to allow him to enter data for characteristics of his requests. Screen shot 500 shows a basic GUI layout of text boxes 502 and descriptions 504 that allow user 108 to enter parameters and characteristics for his desired program(s). Once the data is entered, the subscription characteristics can be stored in database 106. For example, boxes 504a-504k allow user 108 to enter data relating to his name,/account, address, insurance information, gender, fitness level, goal, fitness devices, allergies, medications, music accounts, etc.

Data entered from the PLMA is stored in database 106 as a subscription record, but the program record may include additional data. Table B below is an exemplary subscription record for a user.

TABLE B

| Field | Data |
|---|---|
| Name/Account | Alice Bates/User Account 1234 |
| Address (home) | 3 Main Street, |
| | Toronto Ontario |
| Date of Birth | Feb. 28, 1995 |
| Employer: | BigCo. Stores |
| Employer Address: | 18 First Ave. |
| | Toronto, ON |
| Insurance Account | InsureCo Policy 1111 |
| Frequency | Daily |
| Gender | Female |
| Fitness Level | Average |
| Goal | Increased Stamina |
| Plans | Run Marathon, Reduce Stress |
| Intensity Tolerance | Medium |
| Fitness Devices | Electronic Pedometer, Pulse Meter |
| Allergies | Pollen |
| Medications | Penicillin |
| Music Account | Rdio Account 1111 |
| Privacy settings | Personal Data can be shared |
| | Account data cannot be shared |
| | FitGuru cannot receive any personal |
| | data |
| Filters for approved HPs | Ken's Training (all content); |
| (whitelist) | Alice's Yoga (program offerings but |
| | no text messages); |
| | any Yoga trainer within 5 km of home |
| | address; |
| | any fitness programs after 8PM on |
| | Wednesdays within 10 km of work |
| | address |
| Filters for blocked HPs | Jane's Boxing training (all content) |
| (blacklist) | |
| Other parameters | Maximum cost $65/hour, $65/week, |
| | $125/biweekly |
| . . . | . . . |

Table B includes data for privacy settings for the user account, allowing user 108 to select what personal data in the account is private and what data can be shared with whom. More or less fields can be provided to describe a user, her subscription(s) and her plan(s). Fields may or may not be populated for a given program. Table B also includes fields for filters for program(s) and plan(s) for HPs (such as whitelists and blacklists).

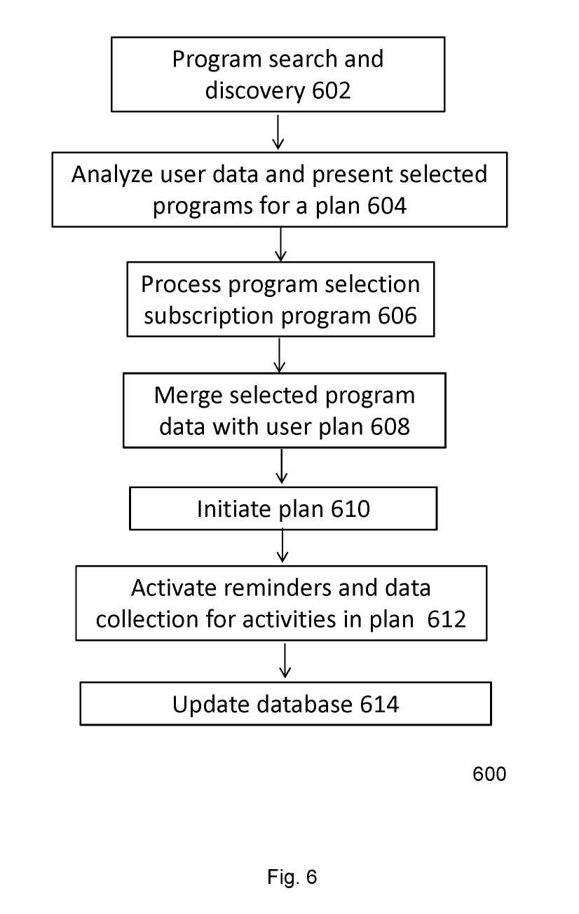

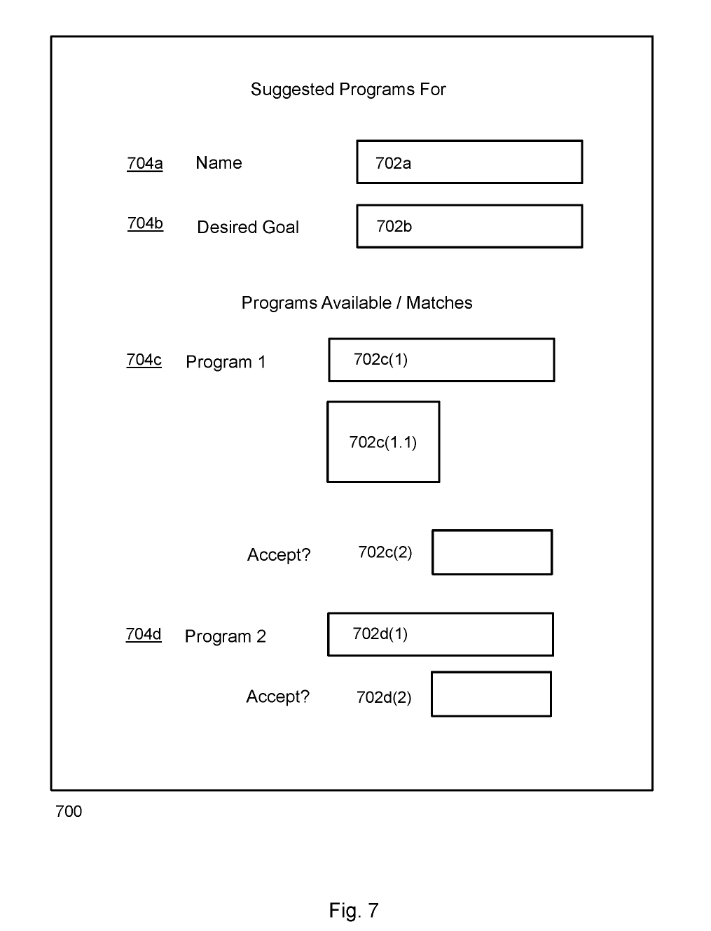

FIG. 6 shows flow chart 600 of functions operating on device 110 in processing subscription requests and subsequent execution of tracking of a program by user 108 as executed by the PLMA. First at process 602, a search for programs in database 106 that sufficiently match parameters of the goals of the user are identified. FIG. 7 shows GUI 700, representing an interface that presents selected programs to user on device 110 as a marketplace paradigm. Text fields 704a-704b state personal and goal data as provided by the user, with values from database 106 provided in fields 702a-702b. Text fields 704c-704d provide identified programs that best match the stated goal/plan. Fields 702c(1) and 702d(1) provide information on the identified programs and may include links to websites, etc. Field 702c(1.1) provides an area where multimedia files (e.g. video clips as provided associated with the program may be generated. Music may be generated from a speaker of device 110. Data/files for these features may be provided as links to data/files in fields 304f (FIG. 3). Fields 702c(2) and 702d(2) provide an activation button to accept the program or not. Once a program is accepted by the user, parameters of the accepted program (and its related activities and links) are stored in database 106 (and/or in device 110) and may accessed by a calendar application operating on device 110 to track and generate reminders on device 110 that produce a physical output (e.g. visual text message, video clip, audio tone, etc.) reminding the user of activities to be completed by the user for the program. Also, upon acceptance of a program, an embodiment may generate and send an electronic message to an account associated with the HP notifying her of the client and the accepted program. The HP may be provided a restricted/redacted list of details and contact information of the user (based in part on data provided The list of programs may be provided in an order of best matches to the user's requirements to worst matches. It will be seen that GUI 700 provides a virtual marketplace that matches goals of a user with programs offered by HPs.

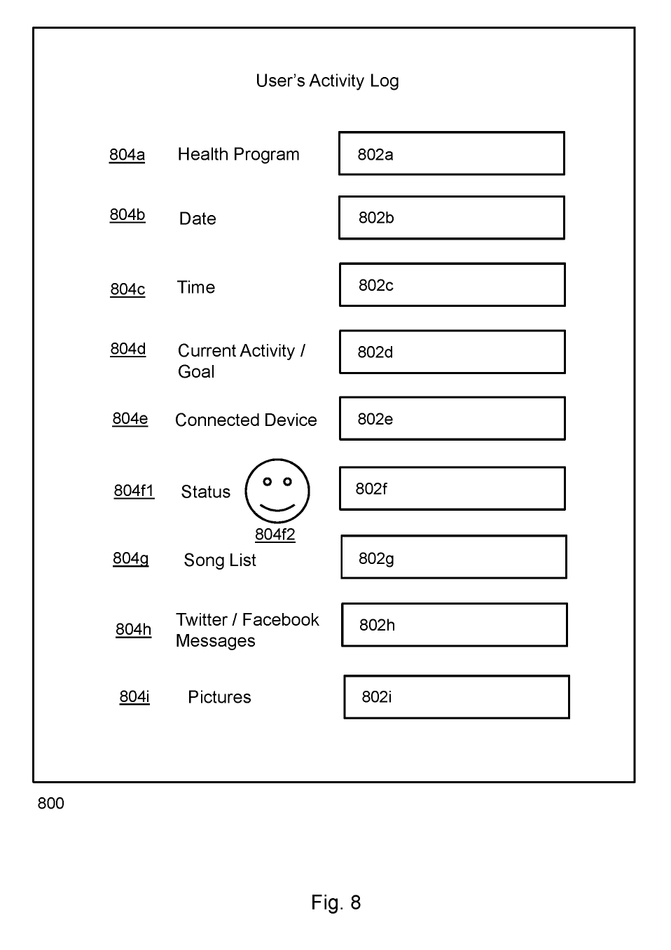

Returning to FIG. 6, at process 604, the user's data is analyzed and a selected group of programs is identified in a GUI. Processes 606-608 provide program selection and merging functions. Processes 610-614 provide program initiation, tracking and data update functions for the tracked program on device 110. In process 612, activation messages may be tracked and sent by server 104/device 110 to monitoring device 112 to initiate telemetrics at the time when the activity starts. Alternatively, user 108 may manually activate the data collection on device 112. FIG. 8 shows GUI 800 showing data on a selected activity of a program in a plan presented to user on device 110. Text fields 804a-804e state data relating to the user, date, time, current activity/goal and connected device, with values from database 106 provided in fields 802a-802e. Additionally, other data may be provided for an activity in other formats. For example, a picture may be provided. If the picture is an image of a report (e.g. a blood work report, showing pH level, glucose level, etc.), then processes are provided to scan the image, extract the text and characterize the text for entry into database as part of the characteristics of the activity. Text field 804f1 and icon 804f2 provide visual indicators on the user's device as to whether or not the current activity has been completed. A completed state may be indicated by a “happy face” icon 804f2; a not completed state may be indicated by a “sad face” icon (not shown). Other visual icons can be used (e.g. a “thermometer” icon providing a rising “temperature” reading as an activity progresses towards completion). Data entry field 802f allows user 108 to enter text relating to the current activity (e.g. “cold outside—running slower and won't complete”). An additional “complete” radio button indicating completion of an activity may be provided (not shown). Text fields 804g-i provide audio/visual motivational mechanisms for user to complete the current task. Field 804g is a song (or song list) that can be accessed by device 110 (or a device communicating with device 110) to allow a previously associated song to be played while that activity is being performed (see the HP's program template, for example). Access information/data associated with the song/song list is provided in field 802g. Fields 804h-i are message/picture areas for electronic messages (e.g. text messages, emails) received by device 110 that are to be associated with the activity (see the HP's program template, for example). The message/pictures are provided in fields 802h-i. Inbound/outbound social network messages (e.g. Twitter, Facebook etc.) may be provided in these fields. The log may be further enhanced with rich multimedia elements (e.g. additional graphics and videos displayed, activity percentage completion meters, cheering sounds, etc.) at specific times during a slated activity to provide more encouragement to the user to complete the activity. For example, if it is determined that the user has not started the activity, additional encouragement messages may be generated on device 110. If it is determined that the user is almost finished the activity, different encouragement messages may be generated on device 110. Other messages (including messages from social network applications), videos, graphics, etc. may be generated on device 110 as relevant times during an activity's execution, depending on a determined state of completion of the activity. Other formats for the log may be provided. For example, entries may be provided in a “calendar” format, a ribbon format (appearing along a bottom of the display of device 110) or in other format in long and short form.

Next, further exemplary details are provided on function c), relating to delivery of selected program(s) to users for their plans. In delivering plans to users on their device 110, on a periodic basis (e.g. daily, hourly, weekly, etc.), an embodiment delivers to the devices 110 the identified plans programs for accounts of their associated users. To do so an embodiment analyzes the subscription data provided by the user and then adapts any generic program to the user's subscription parameters. For example, if the user's goal is to perform one deadlift of 200 lbs 60% of the time, an analysis of the goal may indicate that it is better to perform a deadlift that is likely more achievable, such as one deadlift of 120 lbs. This recommendation may be provided to the HP so that the HP may determine to update characteristics of his program for the user to implement an adjustment for that activity. Alternatively or additionally, aspects of the recommendation may be provided to user. From the subscription parameters, an analysis of all the programs and activities in database 106 is conducted to identify a suite of programs (including partial programs) to achieve the stated goal in a plan. The analysis identifies programs that are best suited for the goal (in whole or in part).

There may be instances where multiple programs from different HPs (or even the same HP) are identified as achieving the same goal. A conflict resolution/program selection scheme is conducted to rank and eliminate as many conflicts as possible/identify the most compatible program(s). In other words, a scheme is provided to select the (most) compatible program(s) for the stated goal. For example, in the standard canonical form for the programs, features like distance of the HP's site to the user and insurance coverage may be matching factors that are used to rank the matching programs. System 100 has a ranked list of factors to apply to arbitrate conflicts and make a program selection. Factors may include: cost, location of HP, shortest times for activities, amount of insurance coverage, most/least amounts of weights for weight training activities, etc. If the conflict cannot be resolved/program cannot be selected within a given matching threshold, then all of the non-resolved conflicting programs may be presented to the user for her selection. Table C provides an exemplary conflict resolution/program selection table:

TABLE C

| Parameter | Data |
|---|---|
| 1. Cost | Select lowest cost for activity |
| 2. Location | Select activity that is indoors/outdoors |
| 3. Proximity | Select activity that is closest to |
| | residence |
| 4. Time | Select activity that has the shorter |
| | completion time |
| 5. Intensity | Select activity that has higher |
| | intensity level |
| 6. Insurance | Select activity that is fully covered by |
| | insurance |
| . . . | . . . |

Conflicts resolution/program selection may be conducted through an analysis of a graph in database 106.

When multiple programs are provided, a merge facility merges and vets activities in the matching programs into a single plan for the user. Again, a list of factors to use in a merging program is provided by an embodiment. Finally, the resulting plan is transformed and enhanced into a rich multimedia representation, for example, using Canvas UX (trademark).

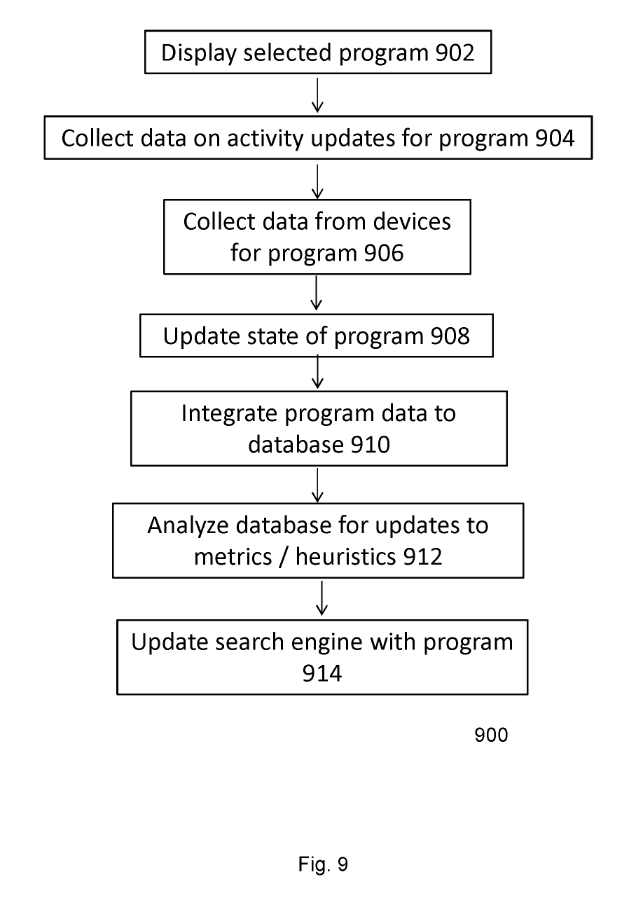

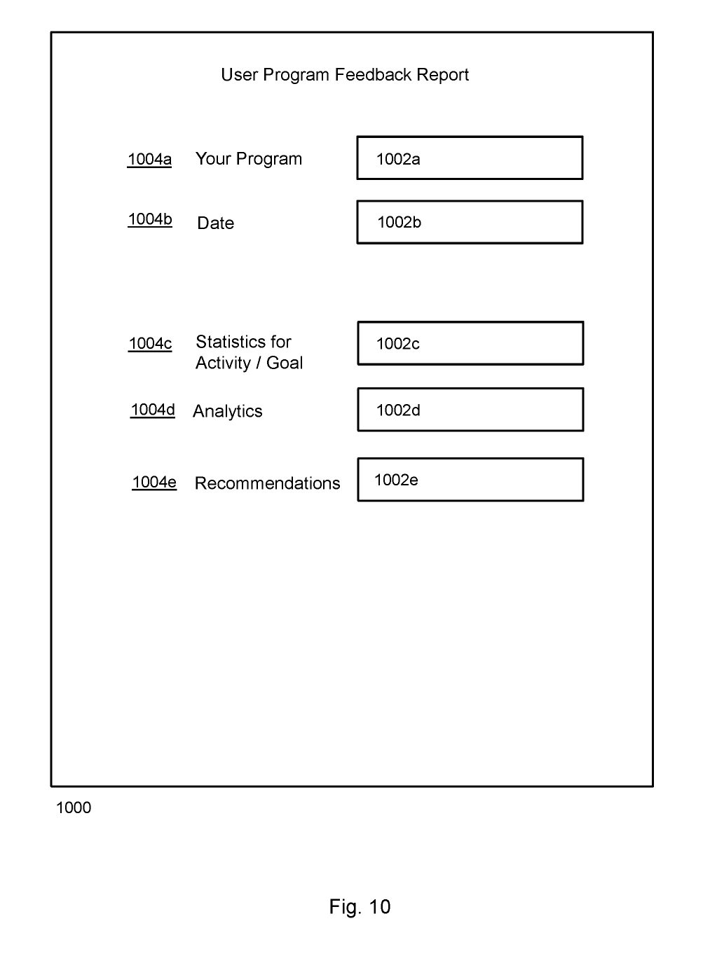

FIG. 9 shows flow chart 900 of functions operating on device 110 and server 104 in developing a personal program in a plan for user 108. First at process 902, the proposed programs are provided to the user (e.g. GUI 700, FIG. 7). Next at processes 904-906, data is collected on activities through various sources such as device 112 and GUIs generated on calendar app on device 110 (e.g. GUI 800, FIG. 8). At process 910, the data is integrated into database 106. At process 912, the program data is analyzed against metrics (e.g. other user's data on similar programs). At process 914, depending on differences detected between the user's performance of the current program and the metrics analysis, recommendations for changes to the user's program may be identified and presented to the user through device 110. If the user accepts the changes, the parameters of the program are updated. FIG. 10 shows GUI 1000 showing a program analysis report presented to user on device 110. Text fields 1004a-1004b state general information relating to the user and the program, with values from database 106 provided in fields 1002a-1002b. Text field 1004c-1004e provide details on the analytics performed and any recommendations with details provided in fields 1002c-e.

As noted above, a health coach may have developed or customized a plan for a user, using the data connection and analysis tools noted above.

As an example of a program selection provided to a user's account for an embodiment, consider an exemplary situation where HP1 is a first fitness instructor and he has created a “high-stamina” program comprising of running 10 km a day 5 days a week and a second fitness instructor HP2 has developed another “high-stamina” program comprising running 20 km a day, on Monday, Wed. and Sat. of every week. User1 has a goal of increasing stamina, but wishes to run no more than 50 km a week. Based on User1's global goal of increasing stamina, both programs by HP1 and HP2 are acceptable; however, with User1's additional qualification to limit a total run to 50 km, the program of HP1 is a more preferred program. An embodiment may present both programs as possible selections to User1, buy would rank the program of HP1 higher than the program of HP2. Alternatively, only the program of HP1 may be presented. In a different scheme, the HP1 program may be presented and only a portion of the HP2 program (e.g. running only on Mon. and Wed.), in view of the distance limitation. It will be appreciated that a matrix of selections of programs, in whole or in part, may be provided based on the features of the programs and the constraints on desired programs provided by the user. The user can then select a mix of programs for his plan.

Next, further exemplary details are provided on function d) monitoring and updating of activity statuses for plans of users. On a periodic basis (e.g. daily, weekly, etc.), a user may update the status of his activities/programs in his plan. For example, user 108 may access GUI 800 (FIG. 8) and update field 804f1 with relevant details, e.g. task has been completed, missed, completed in 20 min, completed 10 repetitions of 140 lbs, etc. He may also have automated messages sent to various social network applications (e.g. Facebook, Twitter, etc.).

In addition, data provided by a third party device 112 or application operating on device 110 (or another device) may provide the details to server 104. Again, device linking information has been provided in GUI 300 (FIG. 3), GUI 500 (FIG. 5) and GUI 800 (FIG. 8). When server 104 receives data from connected devices/application, the data may be transformed into another semantic representation, so that the data may be used to update status of activities in the programs. For example, a representation can be established that data from a RunKeeper application in a certain time frame is meant to represent completion of a run.

Next, further exemplary details are provided on function e) data analysis on activities by users with insight results provided to HPs. Database 106 contains a vast amount of detailed information on activities conducted by users (both within programs and alone). An embodiment analyzes activity updates and other events (e.g. usage data) of user in records in database 106. Additional data may be provided to the system, such as general behavioural data for population sets (e.g. exercise habits of people living in a certain geographic area, etc.) Certain metrics of performances of individual users, groups of users (e.g. by gender, location, age group, etc.) can be generated. An individual's performances can then be gauged against other population groups and reports can be presented to the user on device 110. For example, if a user's progress on his selected program is on track with the goals and in a standard deviation of the population's performance towards goals, then a message can be provided to the user on device 110 indicating same. Metrics may also identify, on a percentage level, whether the user's performance is ahead or behind an average of the field (e.g. program on track, program is 60% completed, metrics are ahead of peers, etc.). Messages indicating same may also be sent and generated.

Next, further details are provided on function f) data analysis providing recommendations and alerts to HPs. As with other database analysis features described earlier, an embodiment analyzes subscription data provided by users (e.g. goals, personal data, tracking devices input) and identifies aspects of programs of HPs that best match those user's characteristics. Messages can be provided to both the user and the HP indicating the high degree of compatibility. This improves a probability that the user will select the program(s) or service(s) of the HP, thereby providing an enhance level of satisfaction for the user for her program and increased clients for the HP.

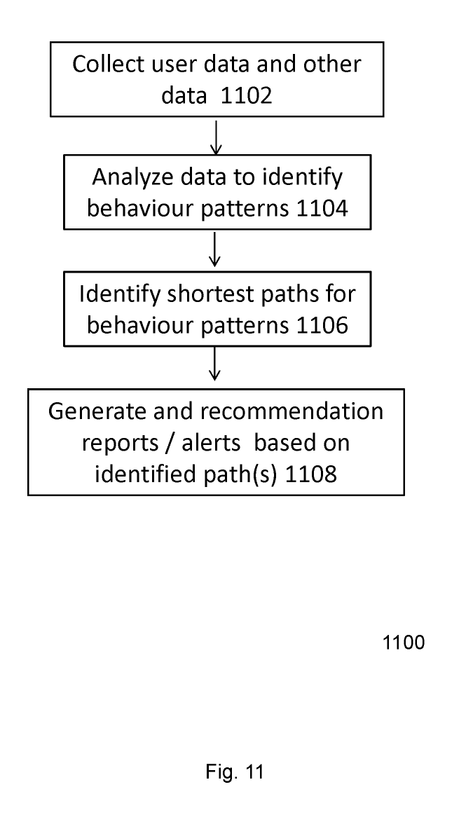

FIG. 11 shows flow chart 1100 of functions operating on server 104 in processing health team management analytics. First at process 1102, database 106 is collected for a user's data on her activities and programs. At process 1104, the data is analyzed for behaviour patterns in the activities (e.g. completion rates on certain days, completion rates of certain activities, etc.). Semantic representations of the user data may be analyzed, using techniques and data described earlier. At process 1106, an analysis of the goals of the user and the current completion level of the user for those goals is conducted. Routes and paths to addressing any shortfalls are identified. This analysis may involve graph theory heuristics. At process 1108, a report is produced and generated and sent the user on the results of the analysis. This report may include data and features shown in GUI 1000 (FIG. 10).

An alert is a particular notification that may be provided as a report to the HP. An alert is triggered when there is non-satisfactory completion of one or more aspects of a program/activity offered by an HP to a user. Feedback received from the user's input/telemetrics may identify when a particular activity is completed, is partially completed, completed with issues, or not completed. Telemetric data that is associated with the activity may indicate unhealthy conditions during the activity (e.g. high blood pressure, heart rate, long completion time, etc.). An analysis of data associated with the activity and the characteristics of the program may trigger different levels of alerts (e.g. low, medium, high, dangerous, etc.) depending on different thresholds for different characteristics (e.g. level of heart rate, level of blood pressure, percentage of completion, etc.).

Now, further exemplary details are provided on function g) relating to health team management. It will be appreciated that an embodiment provides a facility that enables users to create a virtual health team comprising HPs that more closely matched to goals of the user. An embodiment provides a facility that allows users to easily create a virtual health team comprised of HPs that are directly engaged with the user in a single platform. With program development tools, program execution tracking tools and data collection facilities, an embodiment provides: up-to-date reminders and sharing of appointments information, sharing of (selectable) confidential health data between users and HPs and among HPs; management of health team members including adding/removing HPs; communication and programs adjustment based on collaboration between health team members.

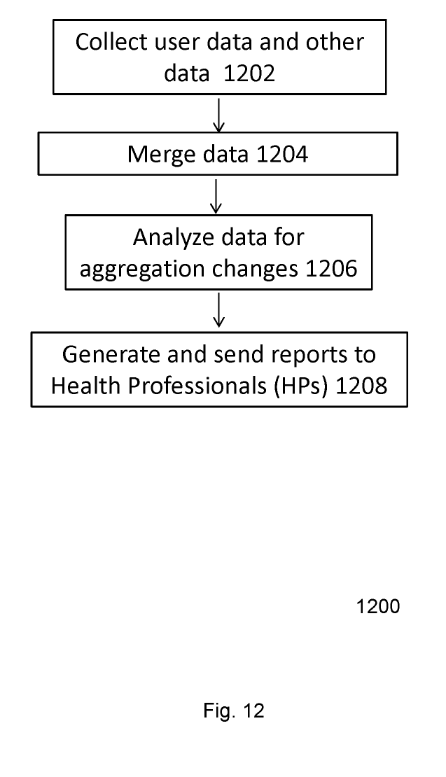

FIG. 12 shows flow chart 1200 of functions operating on server 104 in processing health team management analytics. First at process 1202, database 106 is collected for user data on activities and programs. Semantic representations of the user data may be used. At process 1204, the user data is merged. At process 1206, the data is analyzed for aggregation changes (or other changes). At process 1208, a report is produced and generated and sent to accounts associated with the HPs. The HP report may be similar in content (customized for the HP) to GUI 1000 in FIG. 10.

Now, further exemplary details are provided on function h), relating to management, tracking and presentation of programs and ancillary materials employing social network-focussed functionalities. Therein an aspect of an embodiment generates, manages and updates a GUI on user's device 110 that displays real-time feedback information, messages and data on program(s) being tracked by device 110 (that have been selected for execution as part of a suite of program(s) selected by its user), provides facilities to update, modify, cancel and subscribe to programs from HPs, provides interfaces to communicate with users on other devices/accounts, and generate video, image and multimedia presentations that are associated with either the user, any of the selected program and/or device 110.

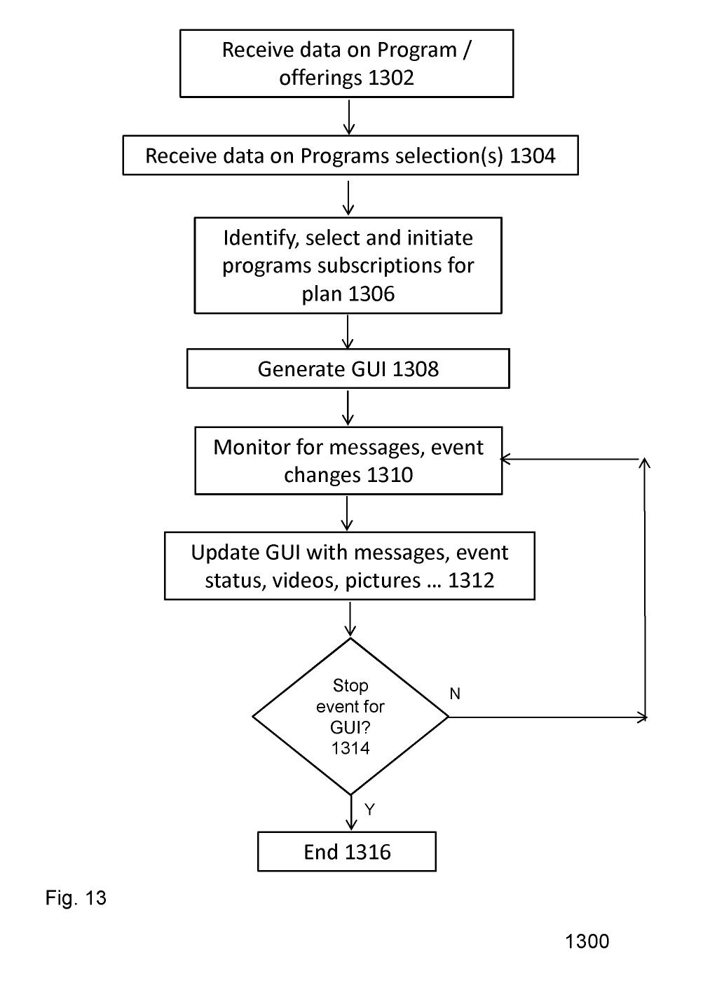

FIG. 13 shows flow chart 1300 of functions operating on device 110 in processing and executing the above-noted social network-focussed functionalities as executed by a social media application (SMA) on operating on device 110.

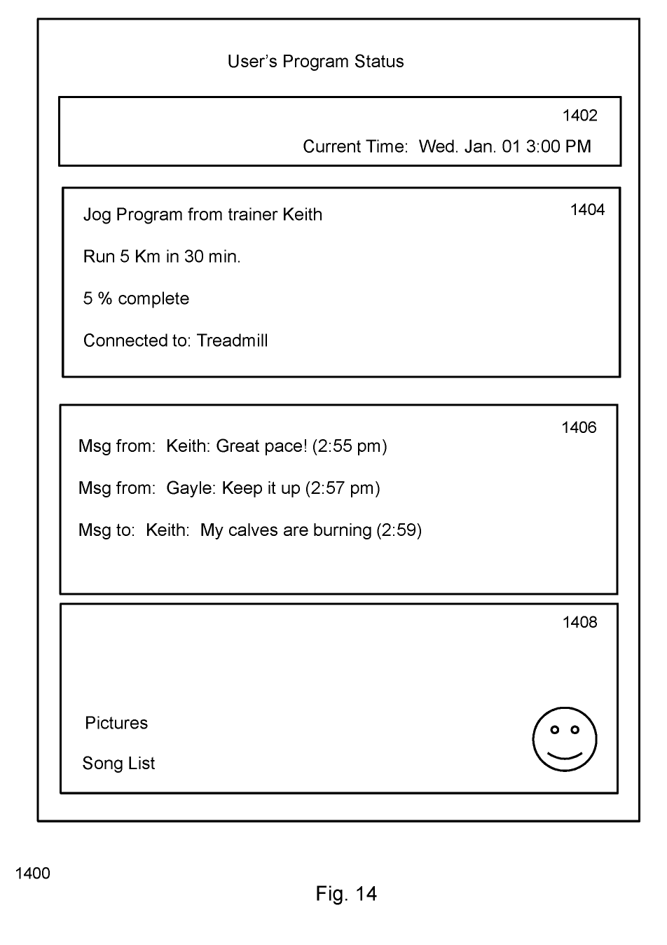

First at process 1302, data is received on a program offerings by HPs, which may be implemented utilizing aspects of processes described earlier for function a) with flow chart 400 (FIG. 4) and an GUI like that shown in screen shot 300 (FIG. 3). Then, at process 1304, data is received on available program selections through a GUI, which may be implemented utilizing aspects of processes described earlier for function b) with flow chart 600 (FIG. 6) and an GUI like that shown in GUI 700 (FIG. 7). Notably, for one embodiment, the programs offered to the user in an electronic marketplace are “pushed” to the user's account. Filters may be presented that may be triggered through a selection in a GUI to show/activate only those programs that pass through the filters' parameters to a user. The parameters may include filters that evaluate data for the programs against data indicating: whether the user has indicated she “likes” the HP, a minimum rating value on a feedback data, a maximum price for service, a location of the HP, times of program(s), etc. The filters and parameters may be presented as selection items in a sub-menu generated on GUI 700. Once a program is accepted by the user, parameters of the accepted program (and its related activities and links) are stored in database 106 (and/or in device 110). Then at process 1306, data regarding the program selections is analyzed to create an implementation plan reflecting exercises, times, goals, videos, text messages and other data and input/output files which can be processed by device 110 to report and monitor activities to be conducted by the user, preferably with device 110 nearby to provide a feedback device for generating outputs (e.g. messages, videos, pictures, graphs, songs, etc.) associated with activities of a program through its progression. At process 1308, the GUI is activated, which creates a virtual GUI on the display of device 110 providing an interface for posting messages, status information and ancillary information about a program and other materials in real time. Referring to FIG. 14, GUI 1400 is shown. GUI 1400 may be separated into several segments that each display different information. One segment 1402 may show general information, such as time, date, location, weather, etc. Another segment 1404 may show information about a program being conducted, such as title, parameters, progress, trainer, etc. Another segment 1406 may show inbound (and outbound) messages (text messages, email, phone call records, etc.), which may be filtered to be related to the program. Another segment 1402 may be reserved for ancillary information related to the program (e.g. a video associated with the program, real times messages from the HP or others providing motivational/status messages on the GUI to encourage the user). Input signals may be received and processed by device 110 relating to data generated from external device during execution of a program. For example, distance/time data may be provided to device 110 from a biometric device worn by a user as she is jogging, to provide feedback information on a jogging component of a plan. Also, data may also be provided as an output signal generated by device 110 as control/data signals to external devices at predetermined times or events for a program. For example, control signals may be generated to adjust a speed/incline of a treadmill for certain stage(s) of the jogging component a program. Also, motivational videos/messages may be generated on a display of device 110 upon completion of a stage of a program. The outputs may be sent from the program or from data provided by the user in selecting the program. Processes 1310, 1312 and 1314 form a loop to monitor for inbound/outbound messages and event changes for the program, update the relevant segment(s) of the GUI with the new items and monitor for an exit instruction (which may be in the form of an exit signal activated when the user activates an “end” command button in GUI 1400 or when an external “end” command signal for the program is received by device 110 (e.g. from a “stop” signal generated by a treadmill upon completion of a designated distance for a run program or from a signal sent by an HP that is monitoring progress of the program remotely, etc.), causing end process 1316 to be executed.

It will be appreciated that in other embodiments, one or more functions provided in flow chart 1300 may be conducted in a server that is in communication with device 110, such as through a web site. A complementary application may be operating on device 110 to provide access to the web site and facilitate files and data provided to the web site from device 110.

Now, details are provided on features related to building, developing, planning, executing and monitoring of an activity plan for a user of an embodiment. As noted earlier, health/activity plans are goal-oriented organizational objects that collect and organize one or more programs, activities, and/or services offered by one or more HPs that provide a service directed to achieving a goal for that plan and/or activities that users select to be added to their health plans with facilities to enable HPs and health coaches to provide comments to the users during a plan's execution. Using a health plan as an exemplary type of plan, details on the selection of the health plan by a user, matching of programs and services from HPs to the health plan, execution, monitoring and feedback for the health plan are provided below. A feature of a health plan is that the plan provides a commonly defined goal (e.g. “Plan to reduce cholesterol level”) that is presented to all users and HPs in the system. The HPs and health coaches may identify and tailor specific program(s) services to that will assist the user in achieving the goal (either in whole or in part) and load the services into the system (e.g. a nutritionist may offer a dietary plan to reduce fat intake to reduce cholesterol intake and a fitness instructor may offer an exercise plan to reduce the cholesterol level). Once the system conducts an analysis of the user's data, the HPs programs and other logistical attributes (e.g. distance of HP from user, price factors, time boundaries, etc.), a “matching” set of programs from one or more HPs can be presented to the user. A health coach is one type of HP that may provide overall consulting services providing recommendations for services to book and/or HPs to connect to the users. Once HPs are fully selected for the plan, selected HPs may contact the user to provide additional information/advice to the user on the applicability of the program to the goal.

A health plan presented in the system can have a pre-built (default) template goals (e.g. “run a marathon”, “train for triathlon”, “try ice climbing”, etc.) but as well, facilities are provided so that users can build and share their customized plans that span different categories of activities (e.g. nutrition goals, exercise goals, spirituality goals, achievement goals, etc.).

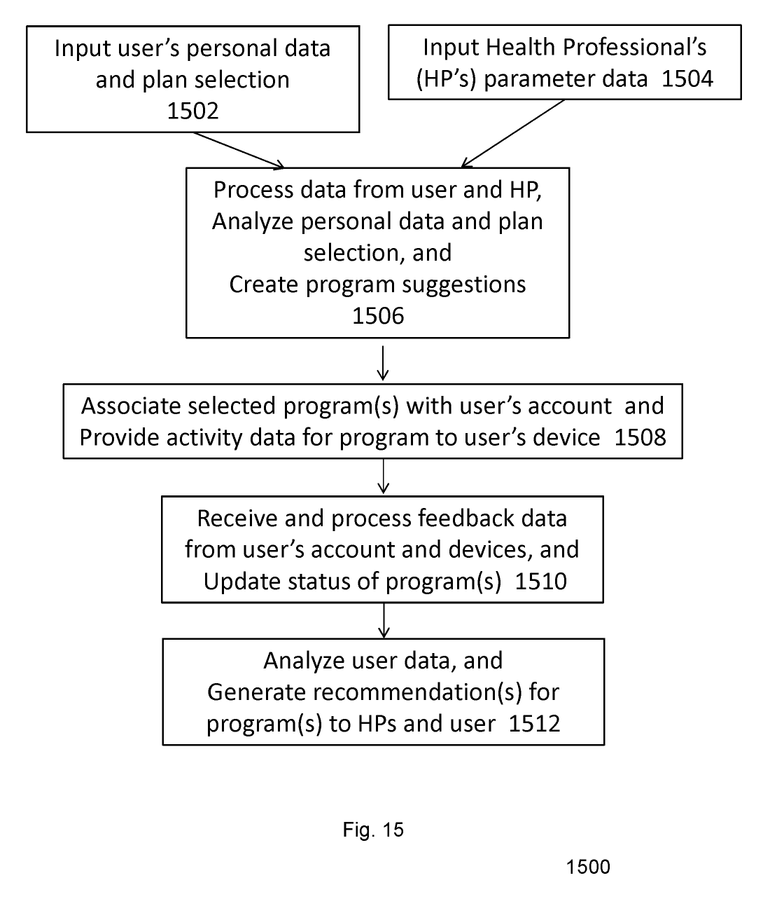

Referring to FIG. 15, flow chart 1500 shows functions and operations executed by various components in system 100 for an embodiment in presentation, selection, execution and management of a plan by a user. Functions in chart 1500 may be independently and in parallel executed by device 110 on users 108, terminals 116 by HPs 114 and by server 104a and database 106.

In flow chart 1500, user 108 may activate a health plan application operating thereon in process 1502. A GUI operating on device 110 may present a series of plans that may be offered to the user. The presented plans may be filtered from a global database of health plan templates stored in the system based on one of more attributes of the user and the available plans (e.g. gender of user, location of user, location of goal, budget/time restrictions set for user, whitelist/blacklist activities for user, etc.) The health plan database may be stored in database 106 and will be used by server 104a to identify a set of proposed programs, which may be an amalgamation of programs offered by HPs 114 that have provided their program data for possible matches to posted plans to server 104 per process 1504.

Note that processes 1502 and 1504 operate independently of each other. Further details on these processes is described below.

Once user and HP data is provided to server 104 and database 106, server 104 processes data from the users and HPs, analyzes the selected health plan and personal data against the program data provided by the HPs, normalizes the data and identifies a set of programs suitable for the plan's goals and abilities (as stated in his program goals and analyzed from his personal data) per process 1506.

When multiple programs are associated with a plan, the related HPs may (or may not) be advised by the system that of the other HPs associated with the plan. If the HPs are made aware of the other HPs, the system may selectively allow one or more HPs to communicate with other HPs. For a plan, the HPs may be ordered in some ranking manner and different privileges and priorities may be set for each HP for the plan. When there is a conflict in programs for a plan, the rankings and hierarchies may be analyzed by the system to resolve the conflict and provide a solution. The solution may be to remove a lower-ranked program by an HP, change times for a program, change a level of activity for a program (e.g. run 3 km instead of running 5 km) and other parameters.

Next at process 1508, once user 108 provides a selection of programs on his device 110 for the plan, server 104 associates the selected programs with the user's plan record in database 106 and generates and provides activity data to the user's device 110. The data is received by the user's device 110 and is accessed by the above-noted plan tracking application operating on device 110.

The application operating on device 110 (described in more detail below), provides a real time calendar application that notifies the user of activities relating to the selected program in his plan (at the relevant start time), provides access to additional details and information (e.g. documents, audio instructions, video clips and song lists) associated with a particular activity and tracks telemetric data and completion notifications for the activity as inputted to device 110. In a different configuration, server 104 provides notification and tracking functionalities of the application operating on device 110.

Next at process 1510, as the application operating on device 110 tracks progress and data for an activity, server 104 receives that data and stores the data in database 106 and updates the status of the related programs being executed for the user's plan. When multiple programs are selected for a plan, individual and cumulative completion data may be tracked and presented on device 110. As with previously described tracking features, activities tracked for the universe of users 108 in system 100 may be updated in system 100 at certain instances or event occurrences. The data relating to activities is analyzed by server 104 and server 104 applies heuristics to identify areas of improvement and/or change for the programs offered by the HPs. When multiple programs are associated with a plan, identified conflicts may be addressed by changing parameters of one or more programs in the plan. Based on the analysis and heuristics, server 104 can generate recommendations for changes to user 108 for his current program/activity for the plan, alerts pertaining to a health condition detected for a user (based in part on feedback provided for his plan being executed) and recommendations for changes to HPs 114 for their offered programs/activity lists. During the plan's execution, social network connections provide feedback and encouragements to the user during execution of the activities.

FIG. 4 and its related description above provide details on how datapoints of a HPs programs and offerings may be received and processed by an embodiment and analyzed against a user's plan.

FIG. 6 and its related description above provide details on how a user's plan is activated and how updates are processed during execution of a plan by an embodiment. FIG. 14 provides an exemplary GUI for the execution status of a user's plan.

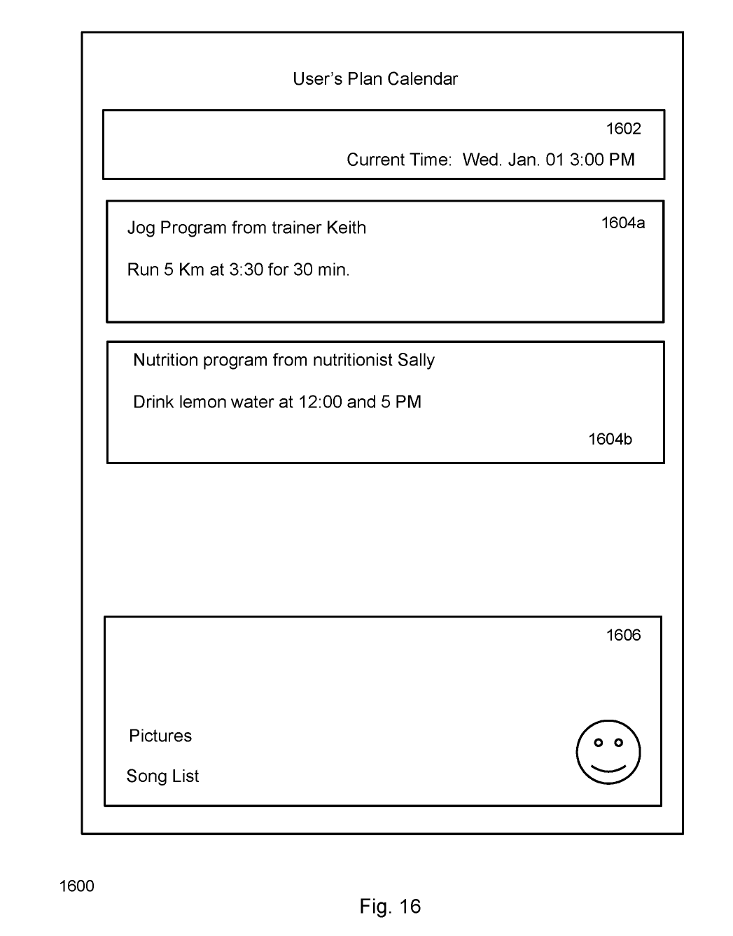

FIG. 16, shows an exemplary GUI 1600 for a calendar application operating on device 110, showing events and activities relating to a plan being executed for the user. GUI 1600 may be separated into several segments that each display different information. One segment 1602 may show general information, such as time, date, location, weather, etc. Other segments 1604a and 1604b may show information about programs being conducted, such as title, parameters, progress, trainer, etc. Another segment 1606 may be reserved for ancillary information related to the program (e.g. a video associated with the program, real times messages from the HP or others providing motivational/status messages on the GUI to encourage the user). Input signals may be received and processed by device 110 relating to data generated from external device during execution of a program.

Now, details are provided on accounting aspects of an embodiment. It will be appreciated that several different tracking and accounting models for system 100 may be provided. In one regime, HPs 114 have accounts with system 100 and their accounts are charged fees for being listed in system 100, for each matching user identified in the initial subscription process and for each actual program accepted by users. Also, users 108 have accounts with system 100 and their accounts are charged fees for being listed in system 100, for each actual program activated by users.

With details on general functions, data, analytics and accounting regimes conducted by an embodiment through server 104 and devices 110, 116 and server 104, further detail is now provided on server 104 and devices 110/116.

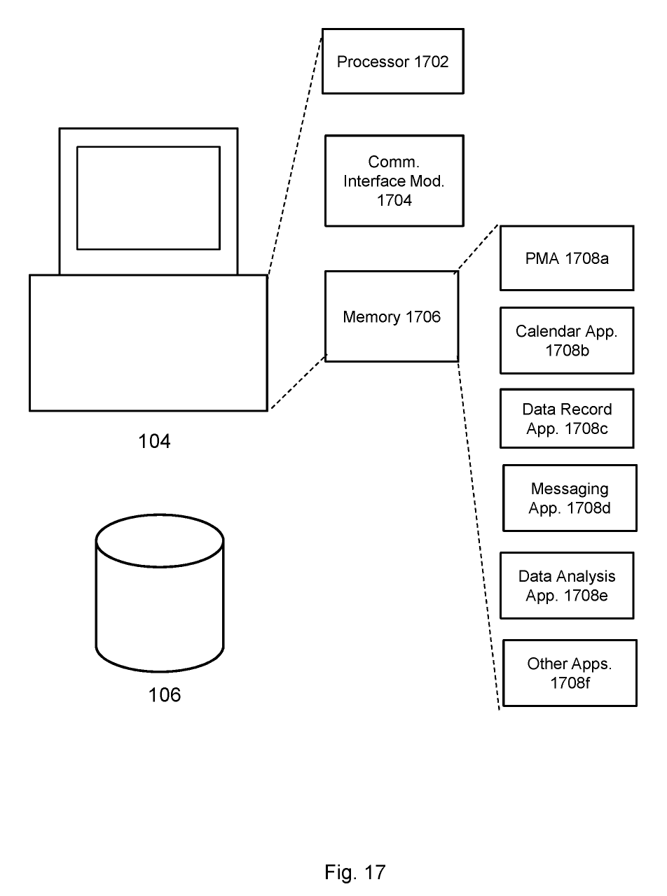

FIG. 17 shows components of an exemplary server 104 as provided by an embodiment. Server 104 is a typical processor based computing machine and as such may be a stand-alone computer, a laptop, a tablet, a server or other computing devices. Server 104 may be accessed directly at its terminal or remotely through a communication network. Server 104 has processor 1702, communication interface module 1704, and memory 1706. Server 104 can communicate and control access/write functions to database 106 through a software application (not shown) and communication interface module 1704. In memory 1706, a plurality of applications 1608 are stored that contain instructions for execution on processor 1702. The applications include a program/plan management application (PMA) 1708a, which implements program/activity/plan management functions executed by server 104 described herein. For example for program management, PMA 1708a analyzes characteristics of a user's selected program and scan the database of HP records for suitable candidate HPs for the program. A matching scale can be provided where datapoints about the user (e.g. location, budget, preferred times/days, likes, dislikes etc.) are compared against datapoints of the HPs (e.g. distance from user, available times/days, costs of programs, focus of programs, etc.) and a matching score may be calculated based on the matches and non-matches of the datapoint comparison. An algorithm used by the application to calculate the matching score may allow different weights to be applied and adjusted to different categories by a system administrator. Calendar application 1708b implements calendar management functions and notifications provided to devices 110/112 executed by server 104 described herein. Data record application 1708c implements device 112/application data collection functions and notifications executed by server 104 described herein. Messaging application 1708d implements device 112 messaging functions and notifications provided to devices 110/112/114 executed by server 104 described herein. Data analysis application 1708e implements database information retrieval and analysis functions executed by server 104 described herein. Other applications 1708f may be provided.

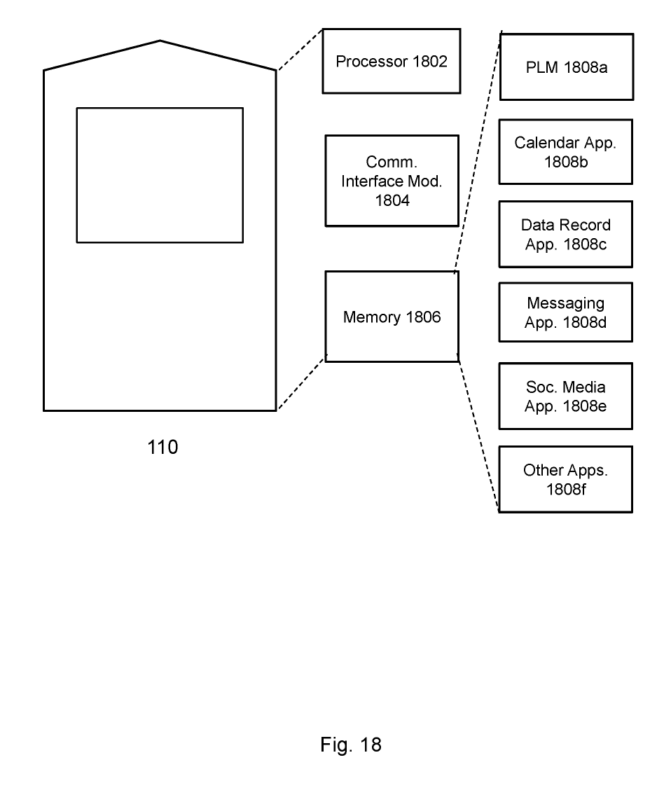

FIG. 18 shows components of an exemplary device 110 as provided by an embodiment. Device 110 is also a typical processor based computing machine and as such may be a handheld electronic communication device, a smartphone, a smart watch, a tablet device, a laptop, a stand-alone computer or other computing devices. Device 110 may access cloud 102 and terminal 116. Device 110 has processor 1802, communication interface module 1804, and memory 1806. In memory 1806, a plurality of applications 1808 are stored that contain instructions for execution on processor 1802. The applications include a plan/program management application (PLMA) 1808a, which implements plan/program/activity management functions executed by device 110 described herein (see plans and programs described in FIGS. 2 and 16 and the related descriptions above). The application may allow the user to provide datapoints about the user's personal data, and preferences for a program or plan (e.g. user's location, budget, preferred times/days, likes, dislikes, specific goals etc.). These datapoints may be compared against datapoints of the HPs (as noted above) to generate a matching score. Calendar application 1808b implements calendar management functions and notifications generated on the GUIs of device 110 as described herein (see FIG. 16 and related description above). Data record application 1808c implements device 112/application data collection functions and notifications executed by device 110 described herein. Messaging application 1808d implements messaging functions and notifications provided by device 110 to server 104 described herein (shown in GUIs in FIGS. 14 and 16). Social media application 1808e implements management of social media connections, status updates messaging functions and notifications provided by device 110 to server 104 described herein relating to processes 1300 (FIG. 13) and 1500 (FIG. 15). Other applications 1808f may be provided. It will be appreciated that terminal 116 may have comparable components and applications to those shown for device 110 herein.

It will be seen that embodiments described herein may provide technical benefits and technical synergies in collecting, analyzing and distributing selected data relating to health records for an individual to one or more (health) service providers, organizing and tracking appointments and program progress and providing feedback and program enhancement videos and music through social network facilities.

It will be appreciated that the embodiments relating to client devices, server devices and systems may be implemented in a combination of electronic modules, hardware, firmware and software. The firmware and software may be implemented as a series of processes, applications and/or modules that provide the functionalities described herein. The modules, applications, algorithms and processes described herein may be executed in different order(s). Interrupt routines may be used. Data, applications, processes, programs, software and instructions may be stored in volatile and non-volatile devices described and may be provided on other tangible medium, like USB drives, computer memories, computer discs, CDs, DVDs or other substrates herein and may be updated by the modules, applications, hardware, firmware and/or software. The data, applications, processes, programs, software, messages and instructions may be sent from one device to another via a data transmission.

As used herein, the wording “and/or” is intended to represent an inclusive-or. That is, “X and/or Y” is intended to mean X or Y or both.

In this disclosure, all adjustment values, decrease values, cut-off values, thresholds and measured value are provided as an approximate value (for example, when the adjustment values is qualified with the word “about”), a range of values will be understood to be valid for that value. For example, for an adjustment value or threshold value stated as an approximate value, a range of about 25% larger and 25% smaller than the stated value may be used. Thresholds, values, measurements and dimensions of features are illustrative of embodiments and are not limiting unless noted. Further, as an example, a “sufficient” completion or match with a given condition or threshold may be a value that is within the provided threshold, having regard to the approximate value applicable to the threshold and the understood range of values (over and under) that may be applied for that threshold.

The present disclosure is defined by the claims appended hereto, with the foregoing description being merely illustrative of embodiments of the disclosure. Those of ordinary skill may envisage certain modifications to the foregoing embodiments which, although not explicitly discussed herein, do not depart from the scope of the disclosure, as defined by the appended claims.

1. A method for managing relationships among records in a database of services provided by health professionals and users, comprising:
creating and maintaining a first set of records in the database for a user, the first set of records including fields for a name, contact information and a goal;
creating and maintaining a second set of records in the database for health professional records in the second set including fields for a name, programs and activities;
analyzing the database to identify a set of health professional records in the second set of records that match the goal in the first set;
generating and sending a set of programs offered by the set of health professionals to an account associated with the user; and
tracking progress of execution of a program of the set of programs from a health professional of the set of health professionals through a network.

2. The method for managing relationships among records in a database as claimed in claim 1, further comprising:
providing through the network an interface for receiving feedback data from the health professional and third party members in the network on the program and for generating audio, graphic and video files associated with the program in a graphical user interface (GUI).

3. The method for managing relationships among records in a database as claimed in claim 1, further comprising:
generating on a device associated with the account of the user a graphical user interface (GUI) providing details of the set of programs;
receiving on the device a selected program from the set of programs;
sending to the database data on the selected program; and
associating the selected program with the first set of records.

4. The method for managing relationships among records in a database as claimed in claim 1, further comprising:
generating on the device associated with the account of the user a second GUI providing details of activities associated with the selected program at times relating to the activities.

5. The method for managing relationships among records in a database as claimed in claim 4, further comprising:
playing on the device a song associated with an activity of the activities when the activity is to be conducted, wherein the second set of records contains details linking the song to the activity.

6. The method for managing relationships among records in a database as claimed in claim 4, further comprising:
tracking telemetrics from a second device providing usage details imparted by the user while executing an activity of the activities.

7. The method for managing relationships among records in a database as claimed in claim 4, further comprising:
tracking completion data of an activity of the activities in the database.

8. The method for managing relationships among records in a database as claimed in claim 7, further comprising:
analyzing the database and the completion data to identify a modification to the goal for the user;
generating on the device a third GUI providing details of the modification relating to the activity;
receiving at the device instructions for any modification relating to the activity; and
updating the database and the selected program with the any modifications to the activity.

9. The method for managing relationships among records in a database as claimed in claim 7, further comprising:
analyzing the database and the completion data to identify a modification to programs in the second set of records;
generating a report providing details of the modification relating to the second set of records; and
transmitting the report to at least one account of a health care professional in the set of health professional records.

10. The method for managing relationships among records in a database as claimed in claim 7, wherein analyzing the database to identify a set of health professional records comprises:
applying a normalization analysis against the programs.

11. The method for managing relationships among records in a database as claimed in claim 1, further comprising:
generating on the device associated with the account of the user a second GUI providing details of a set of health plans available to the user;
receiving on the device a selected health plan from the health plans;
sending to the database data on the selected health plan;
creating and maintaining a third set of records in the database for the user, the selected health plan and health professional records associated with the health plan; and
tracking progress of execution of a program of the health plan through the network.

12. The method for managing relationships among records in a database as claimed in claim 11, wherein:
parameters of the set of health plans were set by a health coach account having access to data relating to the user and the health professional records in the database.

13. A server for managing relationships among records in a database of services provided by health professionals and users, comprising:
a processor;
a first communication link to a database;
a second communication link to a network; and
a memory storage device, containing
a first application providing instructions for execution on the microprocessor to
create and maintain a first set of records in the database for a user, the first set of records including fields for a name, contact information and a goal;
create and maintain a second set of records in the database for health professional records in the second set including fields for a name, programs and activities;
analyze the database to identify a set of health professional records in the second set of records that match the goal in the first set;
generate and send a set of programs offered by the set of health professionals to an account associated with the user; and
track progress of execution of a program of the set of programs from a health professional of the set of health professionals through a network.

14. The server as claimed in claim 13, wherein the memory storage device further contains a second application providing instructions for execution on the microprocessor to:
generate an interface for receiving feedback data from the health professional and third party members in the network on the program; and
generate audio, graphic and video files associated with the program in a graphical user interface (GUI).

15. The server as claimed in claim 13, wherein the first application provides further instructions for execution on the processor to:
generate on a device associated with the account of the user a graphical user interface (GUI) providing details of the set of programs;
receive on the device a selected program from the set of programs;
send to the database data on the selected program; and
associate the selected program with the first set of records.

16. The server as claimed in claim 13, wherein the first application provides further instructions for execution on the processor to:
generate on the device associated with the account of the user a second GUI providing details of activities associated with the selected program at times relating to the activities.

17. The server as claimed in claim 13, wherein the first application provides further instructions for execution on the processor to:
play on the device a song associated with an activity of the activities when the activity is to be conducted, wherein the second set of records contains details linking the song to the activity;
track telemetrics from a second device providing usage details imparted by the user while executing an activity of the activities; and
track completion data of an activity of the activities in the database.

18. The server as claimed in claim 13, wherein the first application provides further instructions for execution on the processor to:
analyze the database and the completion data to identify a modification to the goal for the user;
generate on the device a third GUI providing details of the modification relating to the activity;
receive at the device instructions for any modification relating to the activity; and
update the database and the selected program with the any modifications to the activity.

19. The server as claimed in claim 13, wherein the application provides further instructions for execution on the processor to:
analyze the database and the completion data to identify a modification to programs in the second set of records;
generate a report providing details of the modification relating to the second set of records; and
transmit the report to at least one account of a health care professional in the set of health professional records.

20. The server as claimed in claim 13, wherein the database is analyzed to identify a set of health professional records by:
applying a normalization analysis against the programs.
